(19) United States
(12) Patent Application Publication
(10) Pub. No.: US 2014/0356575 A1
(43) Pub. Date: Dec. 4, 2014

(54) Structural Micro to Nano Layered Composite

(71) Applicants: Guillermo R. Villalobos, Springfield, VA (US); Shyam S. Bayya, Ashburn, VA (US); Woohong Kim, Lorton, VA (US); Bryan Sadowski, Falls Church, VA (US); Michael Hunt, Alexandria, VA (US); Robert E. Miklos, La Plata, MD (US); Colin C. Baker, Alexandria, VA (US); Jasbinder S. Sanghera, Ashburn, VA (US)

(72) Inventors: Guillermo R. Villalobos, Springfield, VA (US); Shyam S. Bayya, Ashburn, VA (US); Woohong Kim, Lorton, VA (US); Bryan Sadowski, Falls Church, VA (US); Michael Hunt, Alexandria, VA (US); Robert E. Miklos, La Plata, MD (US); Colin C. Baker, Alexandria, VA (US); Jasbinder S. Sanghera, Ashburn, VA (US)

(73) Assignee: The Government of the U.S.A., as represented by the Secretary of the Navy, Washington, DC (US)

(21) Appl. No.: 14/294,206

(22) Filed: Jun. 3, 2014

Related U.S. Application Data
(60) Provisional application No. 61/830,401, filed on Jun. 3, 2013.

(51) Int. Cl. B32B 7/02; C25D 1/00; B32B 27/08; B32B 15/20; B32B 15/04

(52) U.S. Cl. CPC B32B 7/02; B32B 15/20; B32B 15/04; B32B 27/08; C25D 1/00; B32B 2250/04; B32B 2250/42; B32B 2307/732; B32B 2311/24; B32B 2311/18; B32B 2333/12; B32B 2375/00; B32B 2457/00
USPC 428/138; 264/241; 428/215; 428/195.1; 428/209; 428/164; 205/76

(57) ABSTRACT

A composite made of alternating layers of elastic and plastic material provides desirable mechanical properties including high toughness. Each layer has a thickness of between 10 nanometers and 500 microns. Plastic materials that may be used include thermoplastic/thermoset elastomers, aluminum, alloys of aluminum, titanium, and alloys of titanium. Elastic materials include various thermoplastic or thermoset polymers, Al₂O₃, SiC, TiB₂ and B₄C.

### CROSS-REFERENCE TO RELATED APPLICATIONS

This Application claims the benefit of U.S. Provisional Application No. 61/830,401 filed on Jun. 3, 2013, incorporated herein by reference in its entirety.

### BACKGROUND

Traditional methods of making composites having layer thicknesses on the order of micrometers and/or nanometers (termed micro and nano layered composites) are geared towards making small electronic subassemblies or one-of-a-kind lab curiosities, and rely on deposition or infiltration techniques that are not economically or industrially feasible for making large structural components.

Layered or laminar composites do exist for electronic applications, however the layers vary in electrical properties without regard to mechanical properties. They are made by deposition or doctor blading techniques and consist of stacks up to 30 layers thick. The stacks are not structural in nature and are not designed for strength or toughness.

A need exists for lightweight, high strength, and high toughness materials suitable for use as structural components and/or armor applications. Previously developed man-made materials fail to exhibit all these properties to the extent desired. For example, steel possesses high strength and toughness but is extremely heavy. Ceramic materials (boron carbide and silicon carbide) are light and strong but are not tough. Traditional composites (such as fiber-reinforced polymers) try to bridge the gap between light weight, strength and toughness. Unfortunately, the resulting mechanical properties of man-made composites are an average of the components resulting in a material with properties in between its components. In biological composites such as fish scales and the shells of crustaceans and gastropods, however, both strength and fracture toughness exceed the values of the components.

### BRIEF SUMMARY

In one embodiment, a composite material includes at least two layers of an elastic material that exhibits <0.2% deformation before fracture, and at least two layers of a plastic material that exhibits >0.2% deformation before fracture, wherein each layer has a thickness of between 10 nanometers and 500 microns, and wherein the layers of the elastic material alternate with layers of the plastic material and are configured in a stack.

In another embodiment, a composite material includes alternating layers of an elastic material selected from the group consisting of ceramic materials such as, but not limited to Al₂O₃, SiC, TiB₂ and B₄C and layers of a plastic material selected from the group consisting of metals or polymers such as, but not limited to high density polyethylene (HDPE), poly(methyl methacrylate) (PMMA), aluminum, alloys of aluminum, titanium, and alloys of titanium, wherein each layer has a thickness of between 10 nanometers and 500 microns, wherein the layers of the elastic material alternate with layers of the plastic material and are configured in a stack, and wherein the composite material in a state of having been subjected to being pressed into a monolithic composite by treatment with elevated temperature and pressure.

In a further embodiment, a method of making a composite material includes providing an original layer such as a foil or sheet with a thickness range of 10 nm to five millimeters; coating the original layer with a first coating of either (1) a first elastic material or (2) a first plastic material then applying to the first coating a second coating of either (1) a second elastic material or (2) a second plastic material then continuing to alternatively apply elastic and plastic layers until the desired number of layers is reached, and wherein the composite material comprises at least one elastic material and at least one plastic material, and wherein each of the coatings is applied via rolling, extruding, doctor blading, pressing, deposition, spin casting, anodizing, or a combination of these techniques and has a thickness of between 10 nanometers and 500 microns.

### BRIEF DESCRIPTION OF THE DRAWINGS

FIG. 1 is a scanning electron microscopy (SEM) image of abalone shell showing layer structure. Light plates are aragonite that are held together by proteins.

FIGS. 2A through 2E show examples of stacking schemes.

FIG. 3 is a SEM image of an elastic layer flexed to generate gaps.

FIG. 4 is a SEM image of Al₂O₃ anodized on Al foil.

FIG. 5A shows a 240 alternating layer Al/Al₂O₃ composite. FIG. 5B shows a SEM cross section of layered composite (darker material is Al and lighter material is Al₂O₃) showing ‘brick and mortar’ structure as well as discontinuous kinks

### DETAILED DESCRIPTION

Definitions

Before describing the present invention in detail, it is to be understood that the terminology used in the specification is for the purpose of describing particular embodiments, and is not necessarily intended to be limiting. Although many methods, structures and materials similar, modified, or equivalent to those described herein can be used in the practice of the present invention without undue experimentation, the preferred methods, structures and materials are described herein. In describing and claiming the present invention, the following terminology will be used in accordance with the definitions set out below.

As used in this specification and the appended claims, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

Description

Several biological systems increase both the strength and toughness by combining a hard (elastic) and a soft (plastic) material into a light weight layered composite. (see refs. 1-4) Note that for the purposes of this invention ‘elastic’ and ‘plastic’ refer to material properties, these terms are not used as synonyms for a polymer material. An elastic material does not permanently deform prior to fracture while a plastic material will permanently deform before fracture.

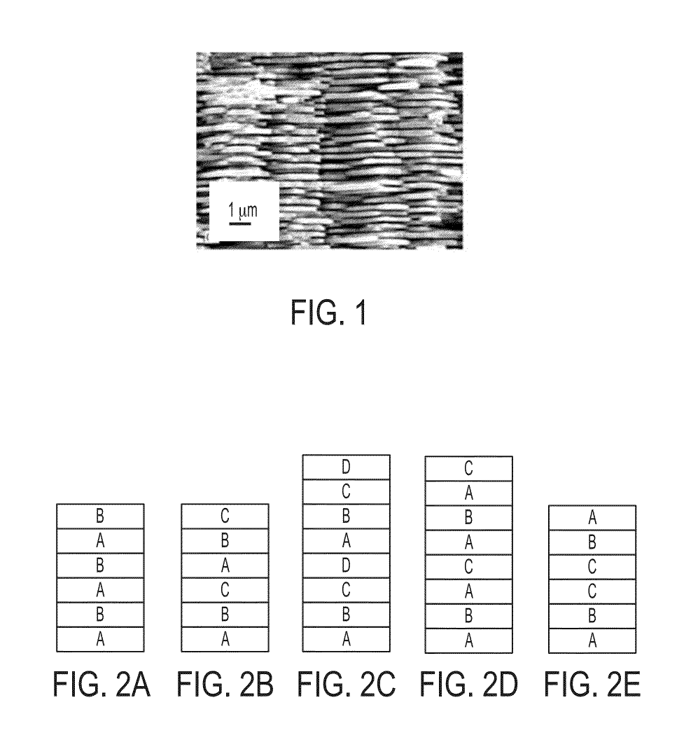

Gastropod shells are in general composed of fairly weak and brittle calcium carbonate plates cemented together by protein (FIG. 1). The bio composite structure can have up to 3000× higher work of fracture and 55× higher fracture toughness than what their individual components would indicate. Efforts to reproduce these structures with ceramics and polymers have been limited to using soft ceramics and/or micron sized features (see refs. 5-7). Although increases in fracture toughness of 10× have been documented in biomimetic composites, the incredible increases found in nature have not. (see ref. 8).

The difficulty attaining the strength and toughness traits found in nature is believed to be due to the methods used to produce these biomimetic structures. Some researchers use ceramics that naturally form plate-like structures, such as clays and layered silicates as the elastic phase and impregnate with a polymer to make the plastic phase. Unfortunately these composites don't live up to expectations due to: (1) the lack of strength of the clays and layered silicate materials, (2) the fact that the thickness of the layers is set by nature and cannot be changed to optimize the composite, and/or (3) because the infiltrated polymer cannot be made to fully impregnate the composite. (see refs. 7-9) Others use stronger materials such as aluminum oxide that are freeze dried to crack the microstructure. The cracks are then impregnated with polymer. (see ref. 9) While aluminum oxide is a very good ceramic material, the size and geometry of the freeze cracked layers are not consistent, cannot be optimized in terms of shape or thickness, and incomplete polymer impregnation remains a problem. In general, existing techniques make use of naturally occurring materials or randomly caused cracking to form the composite. The materials cannot be engineered to achieve a specific layer thickness or thickness ratio between the layers.

The ability to engineer the mechanical properties of the layers in addition to the size and thickness ratio is important because the stress/strain and stress/strain rate that is needed for manmade systems is more varied and extreme than is found in nature. Accordingly, the sizes of the layers may be configured to tailor the layered composite to better match the loads and strain rates encountered in structural and armor components. Also disclosed are how the layer materials can be changed to further increase the strength or toughness of the layered composite.

As described herein, a desired layer thickness and distribution of elastic and plastic layers is produced and assembled into a resulting composite. The composite is engineered such that the individual elastic or plastic layers can be stacked and combined into high toughness layered composite shapes. The layers need not be continuous. A cross section of the layered composite could appear as a ‘brick wall’ where one or more layers can impregnate or penetrate either wholly or partially adjacent layers. The engineered layer stacks can be combined into non-biomimetic or biomimetic layered composite shapes.

The composite preferably includes at least two layers of an elastic material and two layers of a plastic material, with each alternating layer being in the 10 nanometer to 500 micron range. In embodiments, the composite includes at least three of each type of material. In additional embodiments, the composite includes more than one type of elastic material and/or more than one type of plastic material. The elastic material can include, for example, ceramic, glass, or low ductility (i.e. <0.2% deformation before fracture) metals and polymers. The plastic layer can be made of high ductility (i.e. >0.2% deformation before fracture) metals and/or polymers. Also contemplated is a method for making such a biologically-inspired structural micro to nano layered composite structure.

To prevent confusion in terminology the following definitions will be used herein. The “original layer” preferably initiates the process. The original layer typically has a thickness range of 10 nm to several millimeters (for example, five millimeters) and can be an elastic or plastic material from the metal, ceramic, glass or polymer class of materials. The original layer may or may not be removed and discarded prior to the subsequent stacking steps discussed below. Subsequent layers may be referred to as a “coating” or “coatings” regardless of whether or not they were made by a coating process. The coatings will also be in the 10 nm to 500 μm thickness range and can be an elastic or plastic material from the metal, ceramic, glass or polymer class of materials. The term “component” can refer to either the original layer or a coating. The components can be stacked in repeating patterns. So a two component stacking scheme would be an AB stacking scheme where each letter denotes a different material or a material with different properties. Similarly, the term ABC would denote a 3 component stacking scheme, and so on. FIG. 2 show a few examples of stacking schemes, however this description is not inclusive and many more variations can be envisioned. In the stacking schemes the materials will be differentiated in the basis of their composition, Young's Modulus and/or degree of plastic deformation exhibited before failure.

When is said herein that, for example, elastic material alternates with layers of the plastic material, this does not preclude additional intervening layers: for example in the “ABC” stacking scheme of FIG. 2B any of A, B, and C can independently be an elastic or plastic material, so long as one of each type of material is included.

For handling or other purposes it may be more convenient to stack and partially or wholly fuse or densify several to hundreds of repeating units into a thicker stack. Such assemblies will be referred to as “stacks” and, following an optional finishing process (such as pressing, densification under elevated pressure and temperature, application of a coating, etc.) be referred to as the “layered composite.”

Contemplated herein are both processes to make lightweight, high strength and high toughness layered composites, and the layered composites themselves. The layers thicknesses may be in the 10 nm to 500 micron range. The layers need not be all the same thickness. For example in an AB stacking scheme, A can be 200 nm while B is 20 nm. The layers can be metallic, ceramic, and/or polymeric with repeating stacking schemes of 2 or more layers. The layers can be repeating combinations of materials or material properties.

In one embodiment, the composite includes layers of alternating metal (or alloy thereof) and an oxide of the metal. For example, the layers may be aluminum and aluminum oxide, or titanium and titanium oxide. Also contemplated are composites of a metal and its boride, carbide, or nitride.

The layered composite can be made by stacking a singly coated original layer or an original layer that has two or more coatings. The thickness and composition of the layers depends on, but is not limited to, the strength, toughness, strain rate and can be selected in view of the environmental factors pertaining to the application of the layered composite. The original layer and coating(s) can be made by: rolling, extruding, doctor blading, pressing, deposition, spin casting, anodizing or a combination of these techniques. Depending on the materials, it can be more efficient to use the above techniques to deposit a second or even more coatings on top of the original layer to form the repeating stacking scheme. The stacked original layers with or without coating(s) can be pressed into a monolithic layered composite through the application of heat, pressure or both.

The morphology of the stack can be further refined by purposefully cracking the layers or stacks by flexing, rolling, or other suitable technique to create a cracked pattern and/or discontinuities in layers.

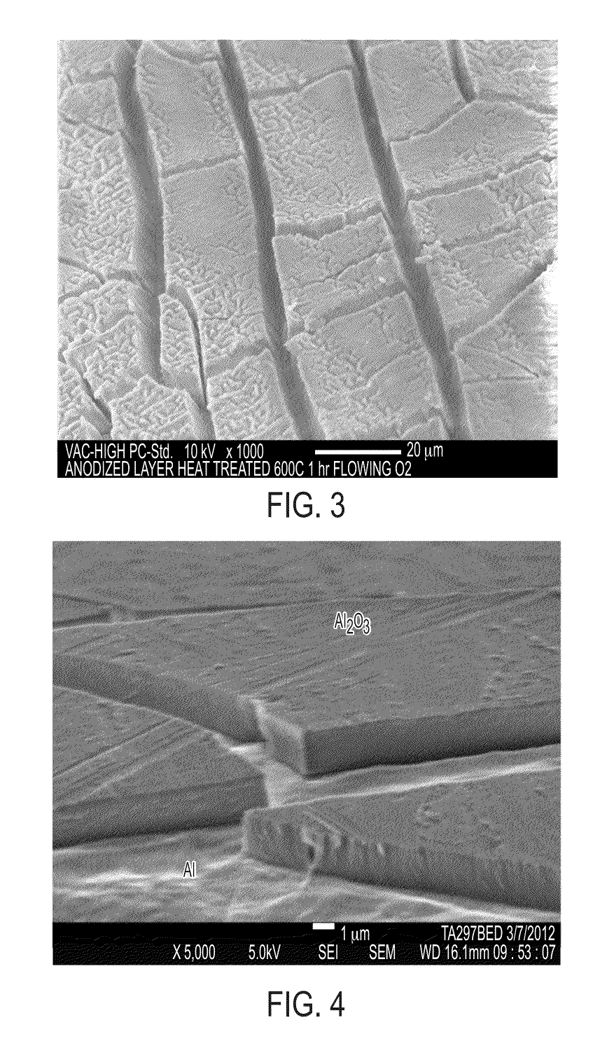

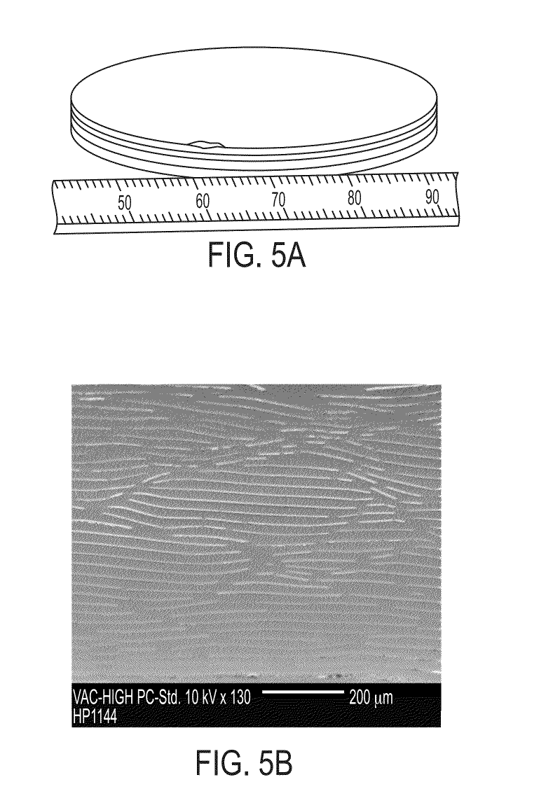

FIG. 3 illustrates how during the pressing step, the plastic layer may be forced into the cracks to create a ‘brick and mortar’ type structure. The size of the features can be controlled by the radius of curvature of the rollers. Rotating the foil 90° and re-flexing can break the structure into individual islands that are cracked in two directions. Intermediate rotations can be used to create a wide variety of geometrical features. As seen in FIGS. 3 and 5, the lateral dimensions of the ‘bricks’ may range from about 10 microns to hundreds of microns.

The strength, elastic modulus, and toughness of the composite can be tailored to optimize the requirements of the layered composite by changing the thickness and thickness ratio of the layers, and also by the size and shape of the ‘bricks’ in the ‘brick and mortar’ structure. Shear strength can be modified by inducing kinks in the layers. The kinks convert shear into partial tensile and compressive loads that reduce or prevent delamination or catastrophic cracking between the layers.

The various embodiments disclosed herein may be combined as evident to a person of ordinary skill in the art.

### EXAMPLES

### Example 1

Aluminum foil of 18 μm thickness was anodized on one side to produce a 3 μm aluminum oxide (elastic) coating on the aluminum (plastic) original layer. FIG. 4 shows the SEM of corresponding Al/Al₂O₃ film. The cracks on the edges of the coating were due to the preparation for the SEM imaging.

### Example 2

Anodized aluminum foils from Example 1 are stacked and pressed at 615° C. at 3000 psi for 1 hour (densified) to obtain a layered composite having continuous Al and Al₂O₃ layers.

### Example 3

The procedures of Examples 1 and 2 where the aluminum foil is a heat treatable aluminum alloy and the resulting composite is heat treated, quenched and aged to achieve increased mechanical properties.

### Example 4

The anodized foils of example 1 are rolled over a 6 mm diameter steel pin to create a linearly cracked elastic layer. The cracked foils are stacked and pressed under the same conditions as example 2 to create a linear brick and mortar structure.

### Example 5

The aluminum foils are purposefully distressed (crunched up) before coating to create a kinked structure. The foils are partially re-smoothed before coating and rolled over a 6 mm pin after coating to form the ‘brick and mortar’ structure. The coated foils were stacked and pressed as in Example 2 to create an intricate structure seen in FIG. 5. The kinked structure provides resistance to shear along the layer direction

### Example 6

The aluminum oxide coating is deposited directly onto the aluminum foil using sputtering techniques. The resulting layers were stacked and pressed at 615° C. at 3000 psi for 1 hour to obtain a layered composite, similar to Example 2. As can be envisioned, other original layer materials and coating materials can be used

### Example 7

One hundred alternating layers of aluminum and aluminum oxide are sputtered onto an original aluminum layer. The resulting multilayer structure is stacked with additional 100 layer multilayer structures and densified using the same procedure as in Example 2

### Example 8

An aluminum foil (18 μm thick) and a doctor bladed/fired aluminum oxide (3 μm thick) free standing sheets are stacked in an alternating scheme and pressed at 615° C. at 3000 psi for 1 hour to obtain a layered composite.

### Example 9

The same procedures are employed as in Examples 1-5 but using titanium original layers and an anodized titanium oxide coating. The layers are densified at 1450° C. using 4000 psi for 1 hour to obtain a layered composite.

### Example 10

Titanium foil is pack borided by ‘painting’ on one side with an industrially known 25% by volume slurry of borax, alumina and boron carbide powders. The painted titanium is dried overnight at 80° C. in air and heat treated at 1000° C. for 1 hour in vacuum. The dried slurry is flaked off leaving a TiB₂ coating on the original Ti layer. The resulting layers are stacked and densified as in Example 9.

### Example 11

Alternating layers of thermoplastic polyurethane and PMMA are spin coated or doctor bladed into manageable thicknesses. The multi-layer stacks are bonded into a layered composite using a laminating press at 130° C., 500 psi and 0.5 hours.

Advantages and New Features

This disclosure teaches engineered layered composites having alternating elastic/plastic layers, or other combinations of material and material properties that one knowledgeable in the art could envision, can greatly increase the strength and toughness of a material while decreasing the overall weight. Coating and stacking of metal sheets and densifying significantly reduces the cost of producing layered composites. This enables direct replacement structural and armor components in existing systems and enables the design of systems that benefit from greater or comparable strength and toughness while reducing weight

Plastic materials that may be used include various thermoplastic/thermoset elastomers,alloys of aluminum, and alloys of titanium. Elastic materials include various thermoplastic or thermoset polymers, Al₂O₃, SiC, and B₄C. Such exemplary materials along with some of their properties are shown in Table 1. Combinations of these, as well as other types of plastic and elastic samples could also be used. It is possible to use clay or mica type materials and infiltrate thereby eliminating the possibility of engineering the thickness and the thickness ratio of the layers, however these materials possess inferior mechanical properties.

TABLE 1
Examples of Plastic and Elastic Materials

| | Plastic | | | | | | |
|---|---|---|---|---|---|---|---|
| | | | Aluminium | Titanium | Elastic | | |
| | HDPE | PMMA | alloys | alloys | Al₂O₃ | SiC | B₄C |
| Young's modulus, | 0.6-1.4 | 1.8-3.1 | 70 | 120 | 340 | 410 | 460 |
| GPa | | | | | | | |
| Strength, MPa | 20-32 | 48-76 | 89-327 | 240-370 | 350 | 600 | 800 |
| Elongation, % | 180-1000 | 2-10 | 20 | 20-30 | 0.1 | 0.1 | 0.1 |
| Density, g/cc | 0.97 | 1.2 | 2.7 | 4.5 | 4.0 | 3.1 | 2.52 |

Concluding Remarks

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

### REFERENCES

[1] B. Smith, et al., Nature, 399, 761 (1999)
[2] R. Z. Wang, Z. Suo, A. G. Evans, N. Yao, and I. A. Aksay, J. Mater. Res., 16, 2485 (2001)
[3] A. G. Evans, Z. Suo, R. Z. Wang, I. A. Aksay, M. Y. He, and J. W. Hutchinson, J. Mater. Res., 16, 2475 (2001)
[4] X. Li, W-C. Chang, Y. J. Chao, R. Wang, and M. Chang, Nano Letters, 4, 613 (2004)
[5] I. Zlotnikov, I. Gotman, Z. Burghard, J. Bill, E. Y. Gutmanas, A. Physiochem. Eng. Aspects, 361, 138 (2010)
[6] E. Munch, M. E. Launey, D. H. Alsem, E. Saiz, A. P. Tomsia, and R. O. Ritchie, Science, 322, 1516 (2008)
[7] P. Padsiadlo, et al., J. Phys. Chem. B, 112, 14359 (2008)
[8] P. Padsiadlo, et al., Science, 318, 80 (2007)
[9] Z. Tang, N. Kotov, S. Magonov, and B. Ozturk, Nature Materials, 2, 413 (2003)
[10] F. Song, A. K. Soh, and Y. L. Bai, Biomaterials, 24, 3623 (2003)

What is claimed is:

1. A composite material comprising:
at least two layers of an elastic material that exhibits <0.2% deformation before fracture, and
at least two layers of a plastic material that exhibits >0.2% deformation before fracture,
wherein each layer has a thickness of between 10 nanometers and 500 microns, and
wherein the layers of the elastic material alternate with layers of the plastic material and are configured in a stack.

2. The composite material of claim 1, wherein
the plastic material is selected from the group consisting of various thermoplastic/thermoset elastomers, aluminum, alloys of aluminum, titanium, and alloys of titanium, and the elastic material is selected from various thermoplastic or thermoset polymers, and group consisting of Al₂O₃, SiC, TiB₂, and B₄C.

3. The composite material of claim 1, wherein at least three layers are present of each of said elastic material and said plastic material.

4. The composite material of claim 1, wherein more than one type of elastic material and/or more than one type of plastic material are present.

5. The composite material of claim 1, wherein the plastic material and elastic material are a metal and a boride, carbide, nitride, or oxide of the metal, respectively.

6. The composite material of claim 5, wherein said metal is aluminum or titanium.

7. The composite material of claim 1, in a state of having been subjected to treatment of the composite material to elevated temperature and/or pressure.

8. The composite material of claim 1, wherein a plurality of layers therein have discontinuities.

9. The composite material of claim 1, wherein at least one layer penetrates either wholly or partially into an adjacent layer.

10. The composite material of claim 1, comprising at least three different plastic and elastic materials.

11. The composite material of claim 1, further comprising an original layer with a thickness of 10 nm to several millimeters.

12. A composite material comprising:
at least two layers of an elastic material selected from the group consisting of thermoplastic or thermoset polymers, Al₂O₃, SiC, TiB₂, and B₄C, and
at least two layers of a plastic material selected from the group consisting of thermoplastic/thermoset elastomers, aluminum, alloys of aluminum, titanium, and alloys of titanium,
wherein each layer has a thickness of between 10 nanometers and 500 microns,
wherein the layers of the elastic material alternate with layers of the plastic material and are configured in a stack wherein a plurality of layers therein have discontinuities, and
wherein the composite material in a state of having been subjected to being pressed into a monolithic composite by treatment with elevated temperature and pressure.

13. A method of making a composite material, the method comprising:
providing an original layer with a thickness range of 10 nm to five millimeters;
coating the original layer with a first coating of either (1) an first elastic material that exhibits <0.2% deformation before fracture or (2) a first plastic material that exhibits >0.2% deformation before fracture, then
applying to the first coating a second coating of either (1) an second elastic material that exhibits <0.2% deformation before fracture or (2) a second plastic material that exhibits >0.2% deformation before fracture, then
applying to the second coating a third coating of either (1) an third elastic material that exhibits <0.2% deformation before fracture or (2) a third plastic material that exhibits >0.2% deformation before fracture, then
applying to the third coating a fourth coating of either (1) an fourth elastic material that exhibits <0.2% deformation before fracture or (2) a fourth plastic material that exhibits >0.2% deformation before fracture, and
wherein the composite material comprises at least one elastic material and at least one plastic material, and
wherein each of the coatings is applied via rolling, extruding, doctor blading, pressing, deposition, spin casting, anodizing, or a combination of these techniques and has a thickness of between 10 nanometers and 500 microns.

14. The method of claim 13, further comprising removing the original layer from the composite material.

15. The method of claim 13, further comprising treating the composite material to introduce discontinuities into at least one of said coatings.

16. The method of claim 13, wherein
each plastic material is independently selected from the group consisting of thermoplastic/thermoset elastomers, aluminum, alloys of aluminum, titanium, and alloys of titanium, and
each elastic material is independently selected from the group consisting of thermoplastic or thermoset polymers, Al₂O₃, SiC, TiB₂ and B₄C.

17. The method of claim 13, wherein each of the plastic materials and each of the elastic materials are a metal and and a boride, carbide, nitride, or oxide of the metal, respectively.

18. The method of claim 17, further comprising wherein said metal is aluminum or titanium.

19. The method of claim 17, further comprising densifying the composite material via treatment with elevated temperature and/or pressure.
